(19) United States
(12) Patent Application Publication
(10) Pub. No.: US 2015/0074561 A1
(43) Pub. Date: Mar. 12, 2015

(54) CUSTOMIZABLE THEMES FOR BROWSERS AND WEB CONTENT

(71) Applicant: Xin ZHOU, Beijing (CN)

(72) Inventor: Xin ZHOU, Beijing (CN)

(73) Assignee: GOOGLE INC., Mountain View, CA (US)

(21) Appl. No.: 12/775,994

(22) Filed: May 7, 2010

(51) Int. Cl. G06F 3/048; G06F 3/01

(52) U.S. Cl. 715/760; 715/765; 715/779

(57) ABSTRACT

A computing device implementing a browser application with an add-on toolbar may provide for customization of the visual appearance of the toolbar. The device may receive a configuration file describing a visual appearance of the toolbar. The configuration file may be stored locally at the client device. The configuration file may be validated to verify that the configuration file is a valid file for changing the visual appearance of the toolbar; and the configuration may be update the visual appearance of the toolbar to correspond to the visual appearance described by the configuration file. In another possible implementation, a theme for a graphical element of a web page may be distributed as a configuration file that can be distributed as a link that can be placed within the link to used to reference the web page.

### BACKGROUND

Many techniques are available to users today to find information on the world wide web (“web”). For example, users often use web browsers and/or search engines to find information of interest.

Browsers may include user choosable toolbars in which onscreen buttons, icons, menus, or other input or output elements may be placed. Frequently, toolbars may be designed by third parties as graphical elements that can be added to the browser and may provide an interface to extend the functionality of the browser. For example, a company that operates a web search engine may release a browser “add-on” that installs a search toolbar in a user's browser. The search toolbar may provide a convenient interface through which products and services offered by the company can be accessed. For instance, the toolbar may provide a graphical box through which search queries can be entered and executed, a graphical button to assist in bookmarking web pages the user finds interesting, and a graph that provides a graphical representation of the relevancy of the currently accessed web page.

A toolbar, when installed in a browser, may include a graphical “theme” based on either the theme being used by the browser and/or the default display elements created by the company that publishes the toolbar. The “theme” of a toolbar may include, for example, the background color of the toolbar, images in the toolbar, or other graphical elements of the toolbar.

### SUMMARY

According to one implementation, a method may include providing a toolbar installed as part of a browser executed by the client device, the toolbar implementing functions to extend the functionality of the browser; receiving a configuration file describing a theme of a visual appearance of the toolbar, the configuration file including a file stored locally at the client device; validating the configuration file to verify that the configuration file is a valid file for changing the visual appearance of the toolbar; and updating the theme of the visual appearance of the toolbar to correspond to the visual appearance described by the configuration file.

According to another implementation, a client device may include a display device, a network interface connected to an external network, and one or more processors. The processors may: display, on the display device, a browser to a user of the client device, the browser enabling the browsing of information received over the network interface; provide a toolbar installed within the browser, the toolbar implementing functions to extend the functionality of the browser, detect a request from the user to change a theme of the visual appearance of the toolbar, the request being received through an interface of the toolbar; present, in response to the request, an interface for selecting, by the user, a configuration file describing a desired theme for visual appearance of the toolbar; validate the configuration file to verify that the configuration file is a valid file for changing the visual appearance of the toolbar; and update the visual appearance of the toolbar to correspond to the theme of the visual appearance described by the configuration file.

In yet another implementation, a computer-readable medium may contain instructions executable by at least one processor. The computer-readable medium may include one or more instructions for providing a toolbar installed within a browser executed by the client device, the toolbar implementing functions to extend the functionality of the browser; one or more instructions to receive a configuration file describing a visual appearance of the toolbar, the configuration file including a file stored locally at the client device; one or more instructions for validating the configuration file to verify that the configuration file is a valid file for changing the visual appearance of the toolbar; and one or more instructions for updating the visual appearance of the toolbar to correspond to the visual appearance described by the configuration file.

In yet another implementation, a method may include receiving a configuration file describing a theme of a visual appearance of a graphical element for a web page; validating the configuration file to verify that the configuration file is a valid file for changing the theme of the visual appearance of the graphical element for the web page; extracting theme attributes from the configuration file; transmitting the web page to a client in which the visual appearance of the graphical element corresponds to the theme described by the configuration file; and updating the theme of the visual appearance of the graphical element for the web page in a online account associated with a user of the client device.

In yet another implementation, a computer-readable medium contains instructions executable by at least one processor. The computer-readable medium may include one or more instructions for receiving a configuration file describing a theme of a visual appearance of a graphical element for a web page; one or more instructions for validating the configuration file to verify that the configuration file is a valid file for changing the theme of the visual appearance of the graphical element for the web page; one or more instructions for extracting theme attributes from the configuration file; one or more instructions for transmitting the web page to a client in which the visual appearance of the graphical element corresponds to the theme described by the configuration file; and one or more instructions for updating the theme of the visual appearance of the graphical element for the web page in a online account associated with a user of the client device.

### BRIEF DESCRIPTION OF THE DRAWINGS

The accompanying drawings, which are incorporated in and constitute a part of this specification, illustrate one or more embodiments described herein and, together with the description, explain these embodiments. In the drawings:

FIG. 1 is a diagram illustrating an overview of an exemplary implementation described herein;

FIG. 2 is a diagram of an exemplary environment in which systems and methods described herein may be implemented;

FIG. 3 is a diagram of exemplary components of a client or a server of FIG. 2;

FIG. 4 is a flow chart illustrating exemplary operations relating to a toolbar theme;

FIG. 5 is a diagram illustrating an exemplary user interface presented to the user in response to selection of a toolbar options button;

FIG. 6 is a diagram illustrating an exemplary theme configuration file; and

FIG. 7 is a diagram illustrating an exemplary user interface that includes a toolbar after a new theme has been applied to the toolbar;

FIGS. 8 and 9 are diagrams illustrating an exemplary browser interface;

FIG. 10 is a flow chart illustrating exemplary operations relating to a theme for a graphical element presented in a browser;

FIG. 11 is a flow chart illustrating exemplary operations relating to a theme for a graphical element presented in a browser; and

FIG. 12 is a diagram illustrating an exemplary browser interface.

### DETAILED DESCRIPTION

The following detailed description refers to the accompanying drawings. The same reference numbers in different drawings may identify the same or similar elements.

### OVERVIEW

Graphical interfaces, such as those presented by browsers, may include third-party add-ons, such as third-party toolbars. Users may wish to customize the visual appearance of these toolbars.

In one described exemplary implementation, a toolbar may include functionality for loading a configuration file that may describe a visual appearance of the toolbar (i.e., the toolbar “theme”). The Application Programming Interface (API) needed to create a user-defined theme may be provided to users of the toolbar. The users may accordingly create and distribute custom themes for the toolbar. By allowing customization of the toolbar themes, user satisfaction with and perceived value of the toolbar may increase.

A “document,” as the term is used herein, is to be broadly interpreted to include any machine-readable and machine-storable work product. A document may include, for example, an e-mail, a web site, a file, a combination of files, one or more files with embedded links to other files, a news group posting, a news article, a blog, a business listing, an electronic version of printed text, a web advertisement, etc. In the context of the Internet, a common document is a web page. Documents often include textual information and may include embedded information (such as meta information, images, hyperlinks, etc.) and/or embedded instructions (such as Javascript, etc.). A “link,” as the term is used herein, is to be broadly interpreted to include any reference to/from a document from/to another document or another part of the same document.

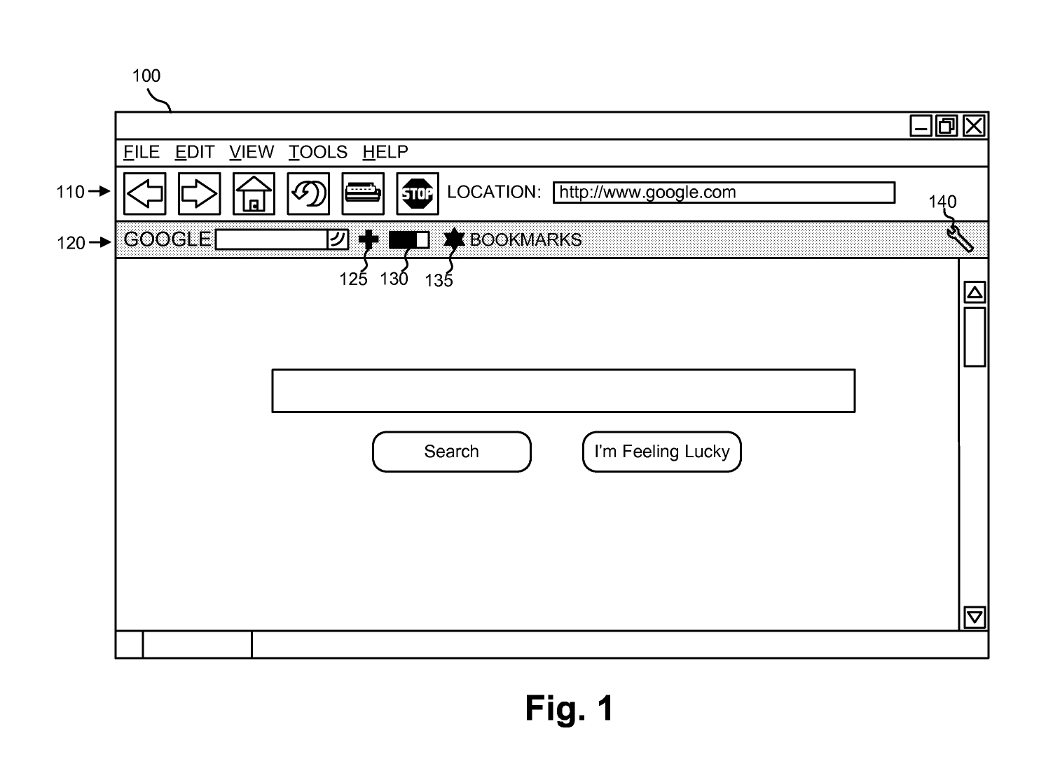

FIG. 1 is a diagram illustrating an overview of an exemplary implementation described herein. As shown in FIG. 1, a web browser 100 includes a standard toolbar 110 and a third-party add-on toolbar 120. The theme (i.e., the visual presentation) of add-on toolbar 120 may be customizable by the user. For example, as shown, add-on toolbar 120 includes a different background color than that used by browser 100. Additionally, other elements of add-on toolbar 120, such as a graphical buttons 125, 130, 135, and 140 may also be customizable as part of the theme. Graphical buttons 125, 130, 135, and 140 may each be used to invoke functionality of toolbar 120. For example, button 125 may be used to add or remove buttons on toolbar 120, button 130 may graphically present a rank of the webpage currently being viewed, button 135 may invoke an interface to organize bookmarks, and toolbar options button 140 may allow the user to adjust the toolbar options.

### Exemplary Environment

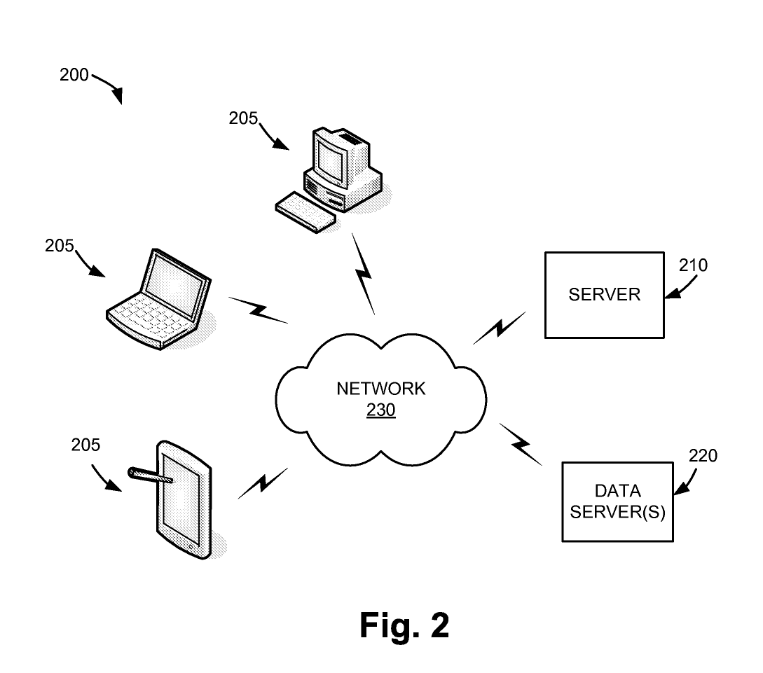

FIG. 2 is a diagram of an exemplary environment 200 in which systems and methods described herein may be implemented. Environment 200 may include multiple clients 205 connected to multiple servers 210 and 220 via a network 230. Three clients 205 and two servers (e.g., server 210 and data server(s) 220) have been illustrated as connected to network 230 for simplicity. In practice, there may be more or fewer clients and servers. Also, in some instances, a client may perform a function of a server and a server may perform a function of a client.

Clients 205 may include client entities. An entity may be defined as a device, such as a personal computer, a wireless telephone, a personal digital assistant (PDA), a lap top, a tablet computer, or another type of computation or communication device, a thread or process running on one of these devices, and/or an object executed by one of these devices. In one implementation, a client 205 may include a user interface (e.g., a browser application) that permits documents to be searched and/or accessed. The browser may be support add-on toolbars that can be customized by a user. Client 205 may obtain the add-on toolbar from a server such as servers 210 or 220. Alternatively, the software for the add-on toolbar may be pre-installed on client 205.

Server 210 may include a server entity that gathers, processes, searches, and/or maintains documents in a manner described herein. In one implementation, server 210 may implement a web service, such as a search engine, that can be accessed by a client 205 through network 230. Data server(s) 220 may similarly include one or more server entities that may, for example, store information, such as documents or images that define toolbar theme configuration information, that may be provided to clients 205. In one implementation, data server(s) 220 may store one or more toolbar themes. Clients 205 may browse the themes and may download and install themes in which the user expresses an interest.

While servers 210 and 220 are shown as separate entities, it may be possible for one or more of servers 210-220 to perform one or more of the functions of another one or more of servers 210-220. For example, it may be possible that two or more of servers 210-220 are implemented as a single server. It may also be possible for a single one of servers 210-220 to be implemented as two or more separate (and possibly distributed) devices.

Network 230 may include any type of network, such as a local area network (LAN), a wide area network (WAN), a telephone network (e.g., the Public Switched Telephone Network (PSTN) or a cellular network), an intranet, the Internet, or a combination of networks. Clients 205 and servers 210-220 may connect to network 230 via wired and/or wireless connections.

### Exemplary Components of Client and/or Server

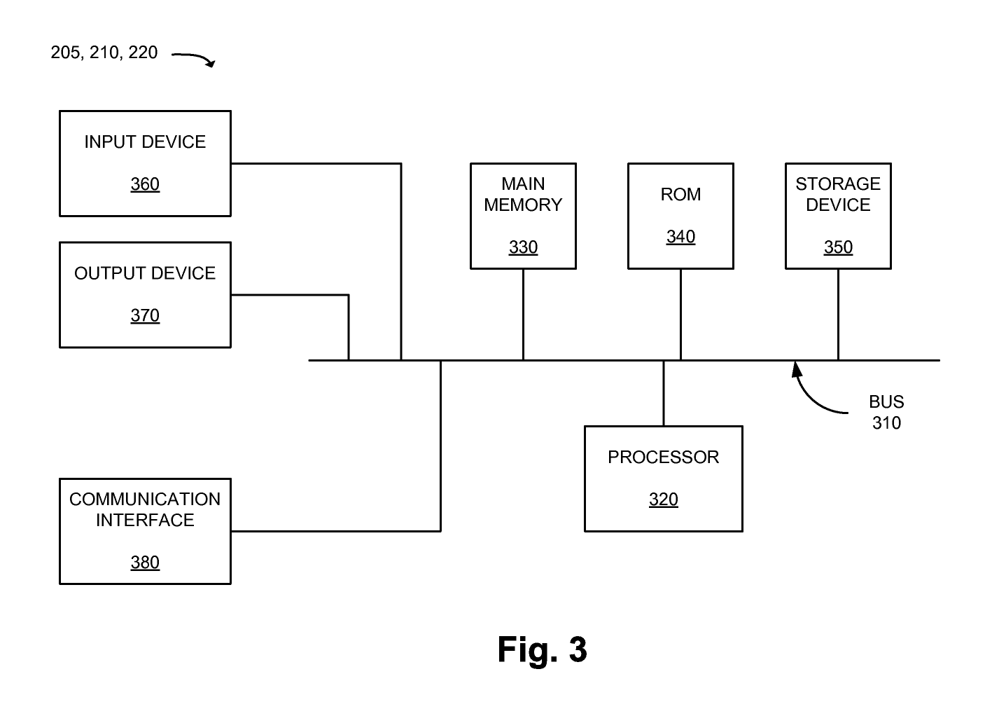

FIG. 3 is a diagram of exemplary components of a client or server entity (hereinafter called “client/server entity”), which may correspond to one or more of clients 205 and/or servers 210-220. As shown in FIG. 3, the client/server entity may include a bus 310, a processor 320, a main memory 330, a read only memory (ROM) 340, a storage device 350, an input device 360, an output device 370, and a communication interface 380. In another implementation, client/server entity may include additional, fewer, different, or differently arranged components than are illustrated in FIG. 3.

Bus 310 may include a path that permits communication among the components of the client/server entity. Processor 320 may include a processor, a microprocessor, or processing logic (e.g., an application specific integrated circuit (ASIC) or a field programmable gate array (FPGA)) that may interpret and execute instructions. Main memory 330 may include a random access memory (RAM) or another type of dynamic storage device that may store information and instructions for execution by processor 320. ROM 340 may include a ROM device or another type of static storage device that may store static information and instructions for use by processor 320. Storage device 350 may include a magnetic and/or optical recording medium and its corresponding drive, or a removable form of memory, such as a flash memory.

Input device 360 may include a mechanism that permits an operator to input information to the client/server entity, such as a keyboard, a mouse, a button, a pen, a touch screen, voice recognition and/or biometric mechanisms, etc. Output device 370 may include a mechanism that outputs information to the operator, including a display, a light emitting diode (LED), a speaker, etc. Communication interface 380 may include any transceiver-like mechanism that enables the client/server entity to communicate with other devices and/or systems. For example, communication interface 380 may include mechanisms for communicating with another device or system via a network, such as network 230.

As will be described in detail below, the client/server entity may perform certain operations relating to the presentation of customized themes. The client/server entity may perform these operations in response to processor 320 executing software instructions contained in a computer-readable medium, such as memory 330. A computer-readable medium may be defined as a logical or physical memory device. A logical memory device may include a space within a single physical memory device or spread across multiple physical memory devices.

The software instructions may be read into memory 330 from another computer-readable medium, such as storage device 350, or from another device via communication interface 380. The software instructions contained in memory 330 may cause processor 320 to perform processes that will be described later. Alternatively, hardwired circuitry may be used in place of or in combination with software instructions to implement processes described herein. Thus, implementations described herein are not limited to any specific combination of hardware circuitry and software.

In one particular implementation, software instructions, such as instructions stored in memory 330, may be executed by processor 320 and may be used to implement toolbars for browser 100. For example, browser 100 may include an API through which developers can create and publish toolbars, such as toolbar 120, that may be installed by users of clients 205.

### Exemplary Toolbar Operation

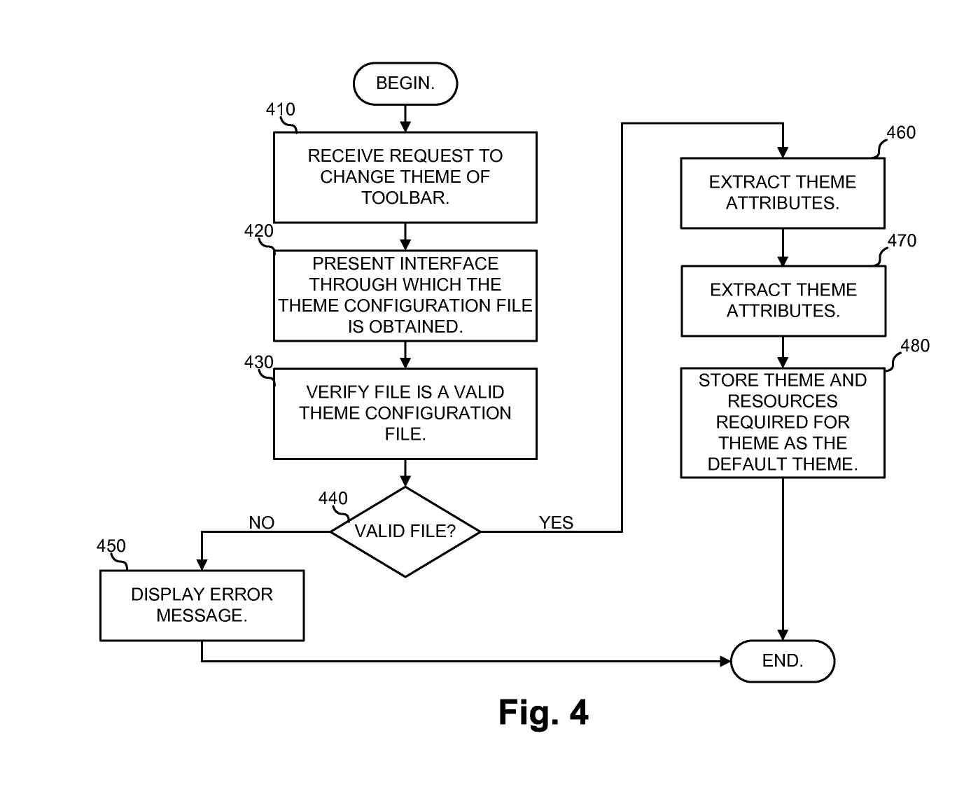

FIG. 4 is a flow chart illustrating exemplary operations relating to a toolbar theme. The operations shown in FIG. 4 may be performed by a toolbar, such as toolbar 120, or a toolbar in conjunction with a browser.

A user may desire to change the theme (i.e., the visual appearance) of a toolbar, such as toolbar 120. Toolbar 120 may be an add-on toolbar that was installed separately by the user from browser 100. The user may indicate that the user would like to change the theme of toolbar 120. In one implementation, toolbar 120 may include a button or other selectable element that the user may select to indicate the toolbar theme is to be changed. For example, toolbar options button 140, when selected by the user, may bring up a list of available toolbar options, one of which may be the ability to change the theme of toolbar 120. Toolbar 120 may receive the request from the user to change the theme of toolbar 120 (FIG. 4, block 410). In response, an interface may be presented to the user through which the user can select a new toolbar theme configuration file (block 420).

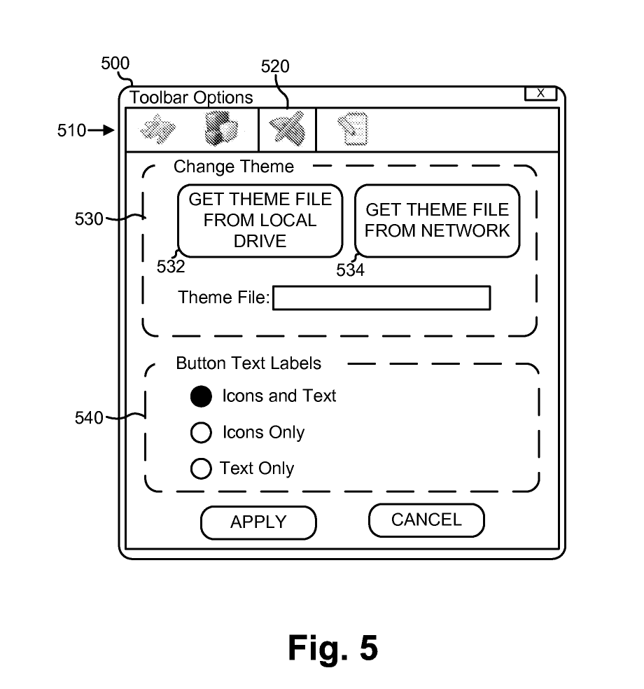

FIG. 5 is a diagram illustrating an exemplary user interface 500 that may be presented to the user in response to selection of toolbar options button 140. Toolbar options interface 500 may include sections through which the user can change options relating to toolbar 120. Toolbar options interface 500 may include a number of tabs 510 that, when selected, may present a different set of options from which the user can select. As shown, layout tab 520 is currently selected by the user. Layout tab 520 may relate to layout options for toolbar 120.

In particular, for layout tab 520, a change theme section 530 and a button text labels section 540 are shown. In change theme section 530, the user may select a new theme to use for toolbar 120. Consistent with aspects described herein, themes may be described for toolbar 120 based on a theme configuration file. As shown, change theme section 530 may provide buttons 532 and 534. Button 532, when selected, may invoke a dialog box though which the user can select a configuration file stored on the user's local drive. For example, the user may have created a theme configuration file or received a theme configuration file from a friend. The user may store the theme configuration file locally and select the theme configuration file using the dialog box invoked by button 532. Button 534, when selected, may assist the user in selecting a configuration file stored remotely, such as over network 230. For example, servers 210 or 220 may maintain a central theme site through which users can upload custom toolbar themes. Button 534 may cause browser 100 to navigate to the theme site, at which the user may browse themes and download configuration files corresponding to desired themes.

In button text labels section 540, users may select whether toolbar 120 displays buttons as text and/or as graphic icons. As illustrated, the “icons and text” option is selected.

Referring back to FIG. 4, the theme configuration file selected by the user in block 420 may be verified as a valid configuration file (block 430). In one implementation, the configuration file may be a text file such as an extensible markup language (XML) file, JavaScript Object Notation (JSON) file, or Protocol Buffer file. In the examples given herein, the theme configuration files will be discussed as an XML file, although in other implementations, the theme configuration files may be implemented using other techniques.

Toolbar 120 may verify the theme configuration file is a valid configuration file by, for example, parsing the configuration file to determine whether the contents of the theme configuration file includes content and/or structure that can be understood by toolbar 120. For instance, the theme configuration file, to be a valid configuration file, may be required to contain certain header information when, if not present, may indicate an invalid configuration file. Alternatively or additionally, a valid theme configuration file may be required to conform to an API that specifies the valid markup or content for the theme configuration file. For an XML configuration file, for example, the configuration file may be required to be constructed based on a set of valid markup attributes. Configuration files that do not contain the valid markup attributes may be determined to be invalid.

If the configuration file is determined, in block 430, to not be valid (block 440—NO), an error message may be displayed to the user (block 450). The error message may indicate that the selected theme configuration file cannot be processed.

If, however, the configuration file is determined, in block 430, to be valid (block 440—YES), toolbar 120 may extract the theme attributes from the configuration file (block 460).

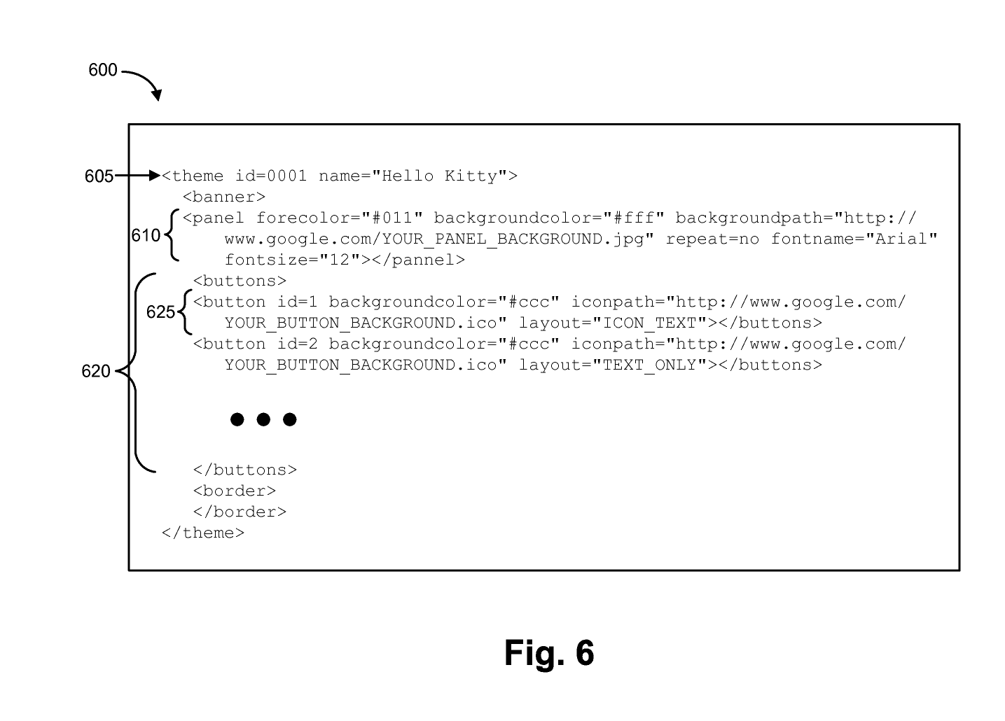

FIG. 6 is a diagram illustrating an exemplary theme configuration file 600. In the example of FIG. 6, theme configuration file 600 is an XML document, although as previously mentioned, theme configuration file 600 may be implemented in other formats. As shown, theme configuration file 600, in line 605, includes the attributes “theme id” and “name,” through which the user may identify the toolbar theme. In section 610, file 600 includes a “panel” section. Panel section 610 may include attributes that describe the main panel of toolbar 120. As shown, the user may specify the foreground color, the background color, a background image (backgroundpath), the font to use, and/or the font size. Other attributes may also be specified in panel section 610. The background image to use for toolbar 120 may be specified in configuration file 600 as a link to a resource, such as a local or remote resource. In the example of FIG. 6, the background image is specified by the link “http://www.google.com/YOUR_PANEL_BACKGROUND.jpg.”

A “buttons” section 620 is also illustrated in FIG. 6. In buttons section 620, users may customize individual buttons on toolbar 120, such as buttons 125, 130, 135, and 140. For example, in section 625, attributes for one particular button is specified. This button has an ID of “one” and may correspond to, for example, button 130 Attributes, such as the background color of the button, the graphic to use for the button (iconpath), and default layout information for the button, may be specified. In alternative implementations, other or fewer button attributes may be specified. The graphic image to use to represent a button may be specified in configuration file 600 as a link to a resource, such as a local or remote resource. In the example of FIG. 6, the graphic is specified by the link “http://www.google.com/YOUR_BUTTON_BACKGROUND.ico”.

As previously mentioned, configuration file 600 is merely one example of a configuration file. In alternative implementations, configuration file 600 may be a text file implemented using standards other than XML and/or may include multiple files, possibly distributed over one or more computers. In yet another possible implementation, the configuration “file” may be a string passed as part of a query string in a uniform resource locator (URL) that is entered into the browser or the toolbar. For example, the user may paste a URL into the toolbar, in which the elements of the URL define all or part of the theme for the toolbar. The toolbar may detect that the URL is a URL that defines a visual theme for the toolbar.

Referring back to FIG. 4, the theme attributes extracted from the theme configuration file, such as file 600, may be applied to toolbar 120 (block 470). As previously mentioned, the theme attributes may generally change aspects of the toolbar, such as the graphic icons shown on the toolbar, the font used in the toolbar, and/or the color scheme of the toolbar. If, for example, the theme configuration file specifies that toolbar 120 is to use a different background color and button 130 is to be displayed using a different representation for the button icon, toolbar 120 may be rendered based on the default theme but using the different background color and button icon.

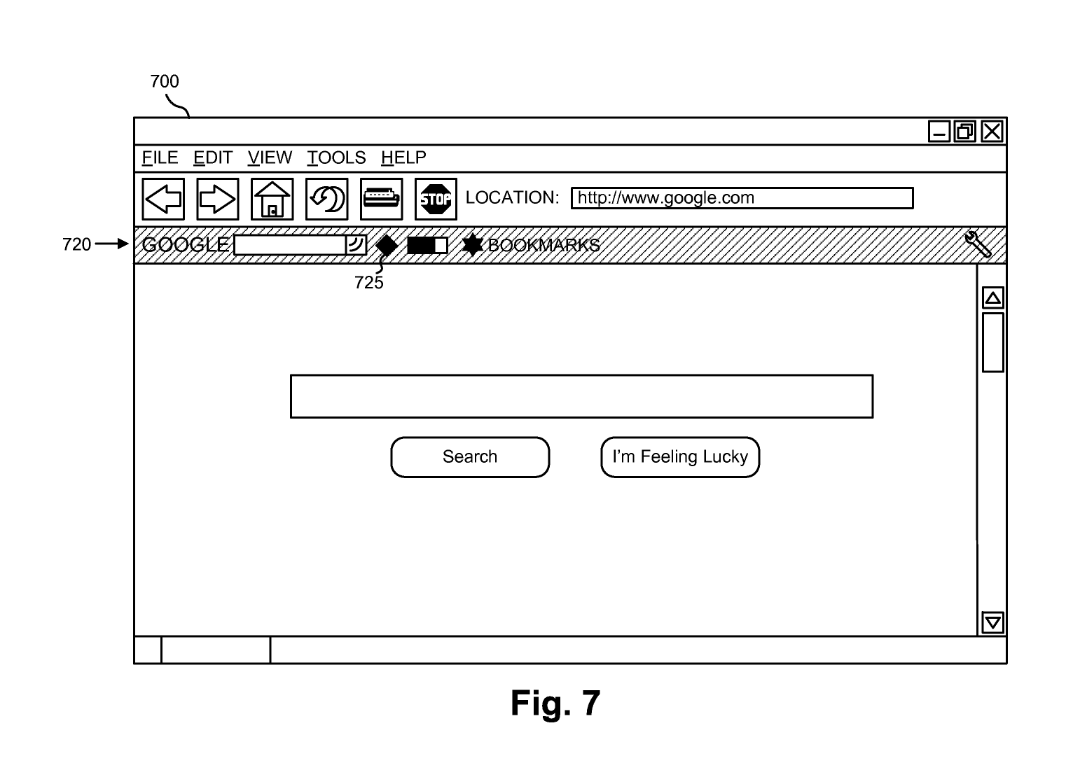

FIG. 7 is a diagram illustrating an exemplary browser interface 700 that includes a toolbar 720 after a new theme has been applied to the toolbar. Toolbar 720 may be functionally identical to toolbar 120 (FIG. 1). Toolbar 720; however, may include a newly applied theme. As particularly shown in FIG. 7, toolbar 720 includes a different background than the toolbar 120, as shown in FIG. 1. Additionally, button 725 is shown as a diamond in FIG. 7 rather than a cross as in FIG. 1 (button 125).

Returning to FIG. 4, attributes and resources, such as graphics references by a theme configuration file, after being applied to a toolbar, may be stored as the default theme (block 480). When browser 100 is re-started, the default theme may be installed for toolbar 120. In one implementation, the default theme may be stored locally, such as on a local drive of client 205, as part of a browser cookie, or as part of a local database. By storing the required theme attributes and resources locally, browser 100/toolbar 120, when re-started, may be able to quickly and efficiently install the user's chosen toolbar theme, even if client 205 is not connected to network 230. In alternative implementations, the theme configuration file may be stored remotely, such as at one of servers 210 or 220.

### Application of a Theme Applied to Other User Interface Elements

The visual theme discussed previously was described as being applied to a toolbar within a browser. Consistent with aspects described herein, a visual theme may be applied to other portions of graphical user interfaces. In one particular implementation, a visual theme may be applied to a browser pop-up box, such as a pop-up box displayed as part of a search query suggestion service.

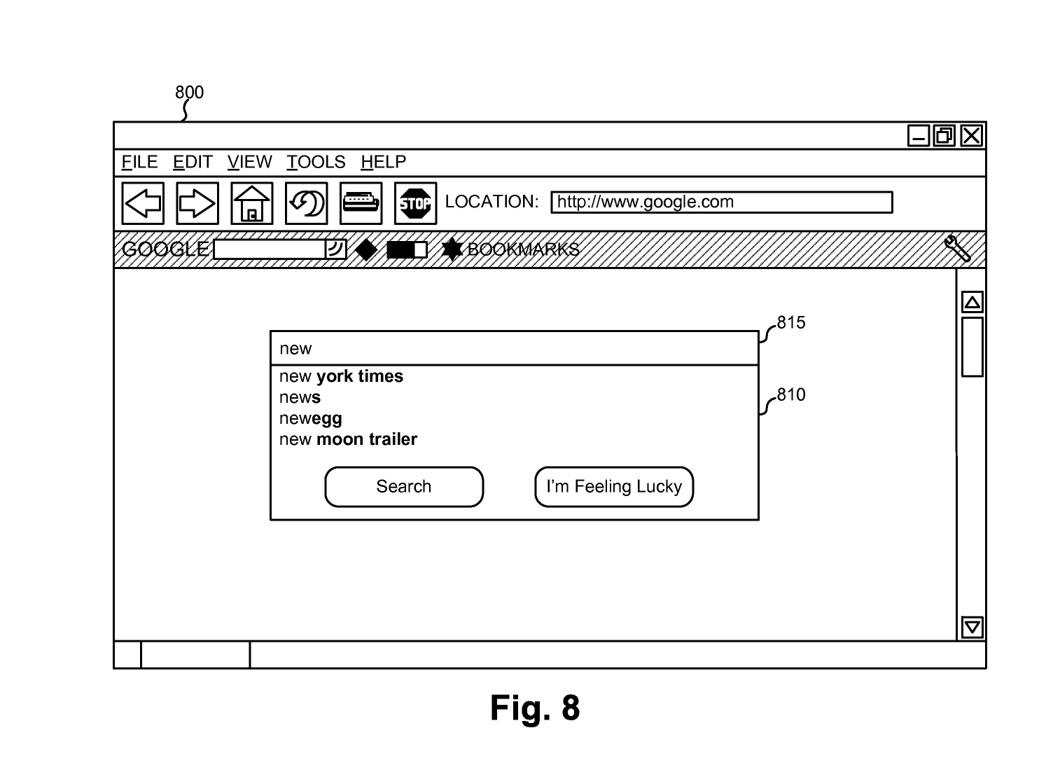

FIG. 8 is a diagram illustrating an exemplary browser interface 800. Assume that the web page, being visited by the browser is a web-page that displays a pop-up window 810 designed to enhance the functionality of the web page. In the particular example shown in FIG. 8, pop-up window 810 may be an interface used to suggest search queries for a search engine. Pop-up window 810 may be presented when the user types search queries into search box 815. One such search query suggestion service is the “Google Suggest” service, provided by Google, Inc. With this service, as the user types into search box 815, browser 800 may communicate with servers 210 and/or data servers 220 to obtain queries for searches similar to the query being typed. These “suggested” queries may be displayed in pop-up window 810. On the client side, the search query suggestion service may be implemented by, for example, javascript that is downloaded as page of the web page and is executed by the browser. The javascript may communicate with servers 210/220 to obtain and present the suggested search queries.

As shown in FIG. 8, the user has typed the search query “new”. As the user enters each letter of the search query, browser 800 may query servers 210/220 to get the suggested search queries and display the suggested search queries in pop-up window 810. In this example, four search queries are suggested: “new york times,” “news,” “newegg,” and “new moon trailer.” If the user, while typing, decides any of these search queries are the search query that the user actually intends to enter, the user may quickly select the desired search query and implement the search.

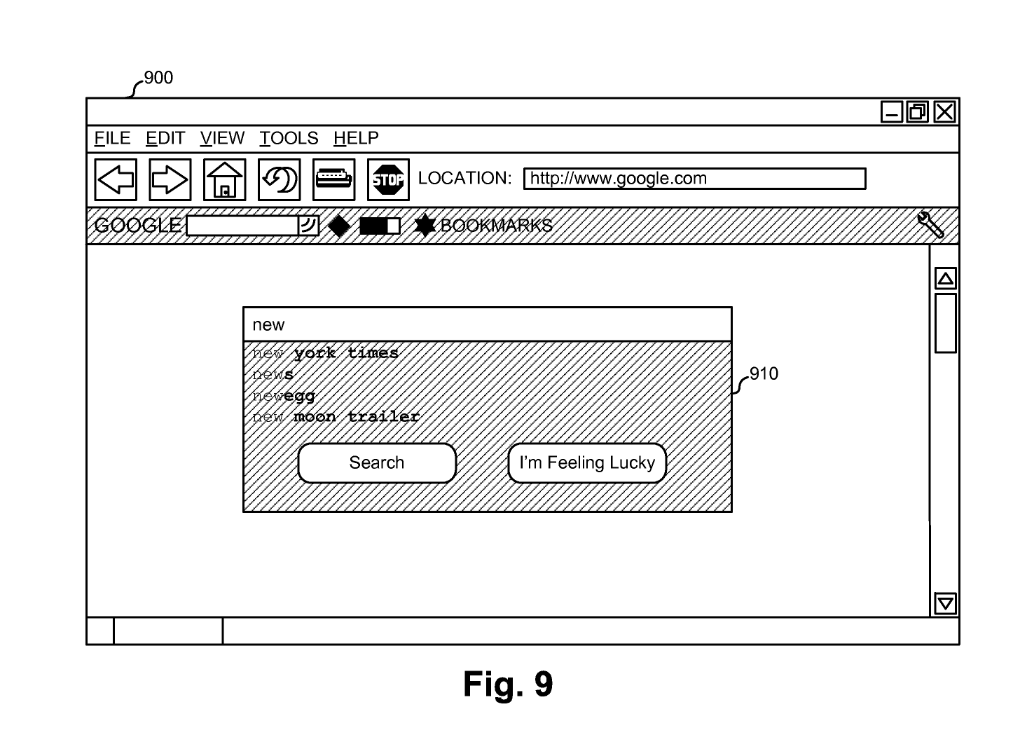

FIG. 9 is a diagram illustrating an exemplary browser interface 900. Browser interface 900 is similar to browser interface 800, except that with browser interface 900, a customized visual theme is illustrated in pop-up box 910. In this example, pop-up box 910 includes a different background and uses a different font than that displayed for pop-up box 810. Functionally, pop-up box 910 may be generally identical to pop-up box 810.

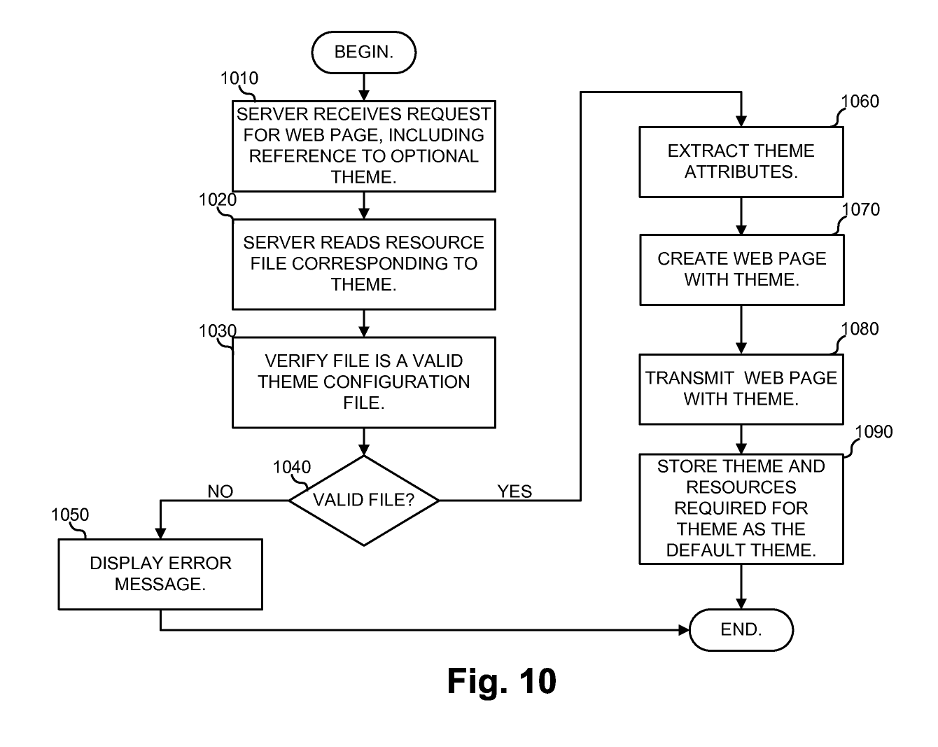

FIG. 10 is a flow chart illustrating exemplary operations relating to the theme of a graphical element presented in a browser. The operations shown in FIG. 10 may be performed by a server, such as server 210, in the process of receiving and responding to a user request for a web page.

A user may desire to change the theme (i.e., the visual appearance) of an interface element, such as pop-up window 810, presented as part of browser interface 800. Alternatively, a developer may wish to test a theme. The theme developer or user may place a reference to configuration file for the theme in, for example, a query string in a link to server 210. For example, the link: “http://www.google.com?suggest_theme=www.mywebsite.com/123.xml,” which references the server “google.com” (e.g., server 210), also includes the query string beginning with “suggest_theme.” The file referenced after “suggest_theme” may be the theme configuration file. When this link is selected by a user, server 210 may receive the request, including the optional query string reference to a theme file (block 1010).

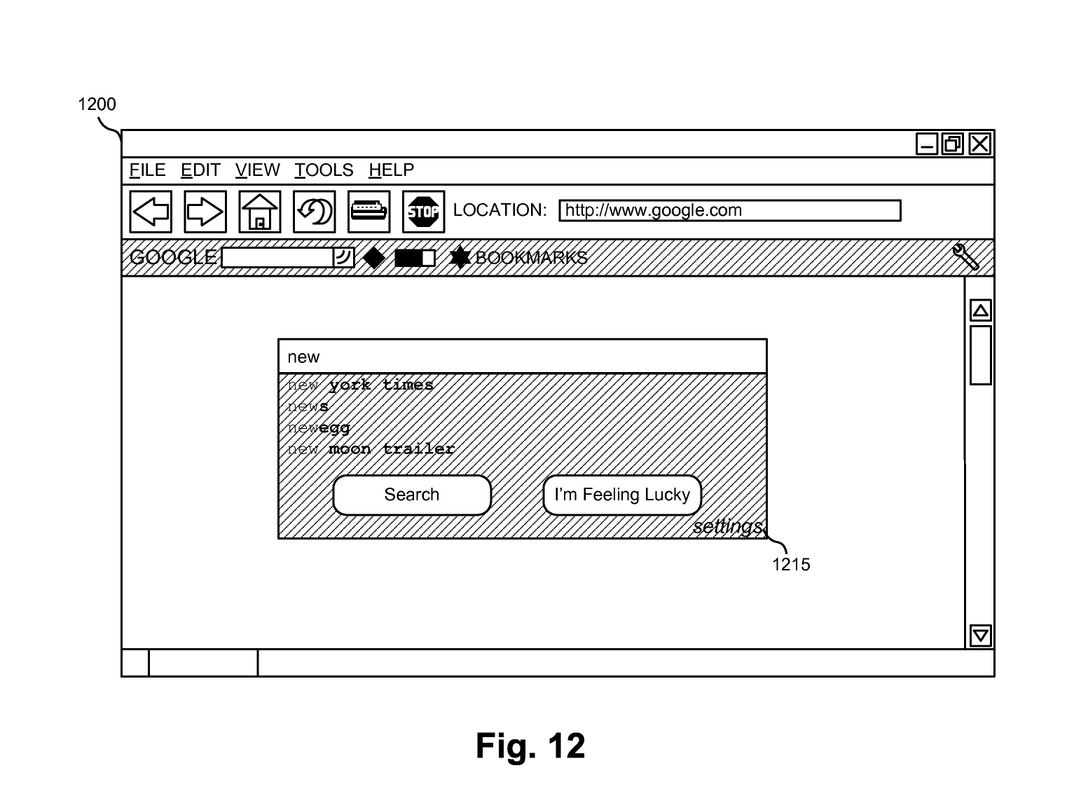

In another possible implementation, instead of embedding a reference to a theme configuration file in a link, pop-up window 810 may include a button, link, or other selectable element that the user may select to indicate the theme of pop-up window 810 is to be changed. FIG. 12 is a diagram illustrating an exemplary browser interface 1200 that includes a link 1215 that, when selected, may allow the user to change a theme of a pop-up window. Interface 1200 is similar to interface 900 except that interface 1200 additionally includes “settings” link 1215. Selection of settings link 1215 may allow the user to change the visual theme of the pop-up window. In particular, selection of link 1215 may result in server 210 responding with a form through which the user can select a theme configuration file. Other techniques for initiating a theme change may be used, such as providing theme configuration information in an options section of a user account, or in response to a selected button on a browser toolbar.

In response to reception of the link for the theme configuration file, server 210 may read the resources corresponding to the theme configuration file (block 1020). For example, for the link given above, server 210 may read the theme configuration file “123.xml” from the address “www.mywebsite.com”. The read theme configuration file may be verified as a valid configuration file (block 1030). In one implementation, the configuration file may be a text file such as an extensible markup language (XML) file, JavaScript Object Notation (JSON) file, or Protocol Buffer file. In the examples given herein, the theme configuration files will be discussed as an XML file, although in other implementations, the theme configuration files may be implemented using other techniques.

Server 210 may determine whether the theme configuration file is a valid configuration file by, for example, parsing the configuration file to determine whether the contents of the theme configuration file includes content and/or structure that can be understood. For instance, the theme configuration file, to be a valid configuration file, may be required to contain certain header information when, if not present, may indicate an invalid configuration file. Alternatively or additionally, a valid theme configuration file may be required to conform to an API that specifies the valid markup or content for the theme configuration file. For an XML configuration file, for example, the configuration file may be required to be constructed based on a set of valid markup attributes. Configuration files that do not contain the valid markup attributes may be determined to be invalid.

If the configuration file is determined, in block 1030, to not be valid (block 1040—NO), an error message may be displayed to the user (block 1050). The error message may indicate that the selected theme configuration file cannot be processed.

If, however, the configuration file is determined, in block 1030, to be valid (block 1040—YES), toolbar 120 may extract the theme attributes from the configuration file (block 1060).

As previously mentioned, the theme configuration file for a pop-up window or other graphical element may be based on a structure similar to that of the configuration file shown in FIG. 6. For example, the theme configuration file may include attributes that allow for the customization of the font used, the background color of the pop-up window, a background graphic to use in the pop-up window, etc. Resources required by the theme configuration file, such as a background graphic to use, may be specified as a link to an external resource.

The theme attributes extracted from the theme configuration file may be used by server 210 to create a web page that includes the specified theme (block 1070). In one implementation, the theme attributes may be applied to a cascading style sheet (CSS) section of HTML that defines the web page. An example of such a CSS section is shown in Table I, below.

TABLE I

<style>

.suggest_box {

border:1px solid #ff0;
background: #fff

url(‘http://www.google.com/hellokitty.jpg’) no-repeat

.....

}

</style>

Alternatively, a CSS file containing the style content, such as that shown in FIG. 1, may be dynamically loaded.

Server 210 may next transmit the web page, including the theme information, back to the developer or user (block 1080). The developer's or user's browser may then render the web page, including the graphical element with the desired theme.

Attributes and resources, such as graphics references by a theme configuration file, after being applied to the pop-up window, may be stored as the default theme (block 1090). When the service provided by the pop-up window is next used, this theme may be applied. In one implementation, the default theme may be stored by server 210 or 220 as part of user account information. One possible advantage of storing the theme information at servers 210/220 is that the user's chosen theme may be applied any computer that uses that service and at which the user is logged in to the account.

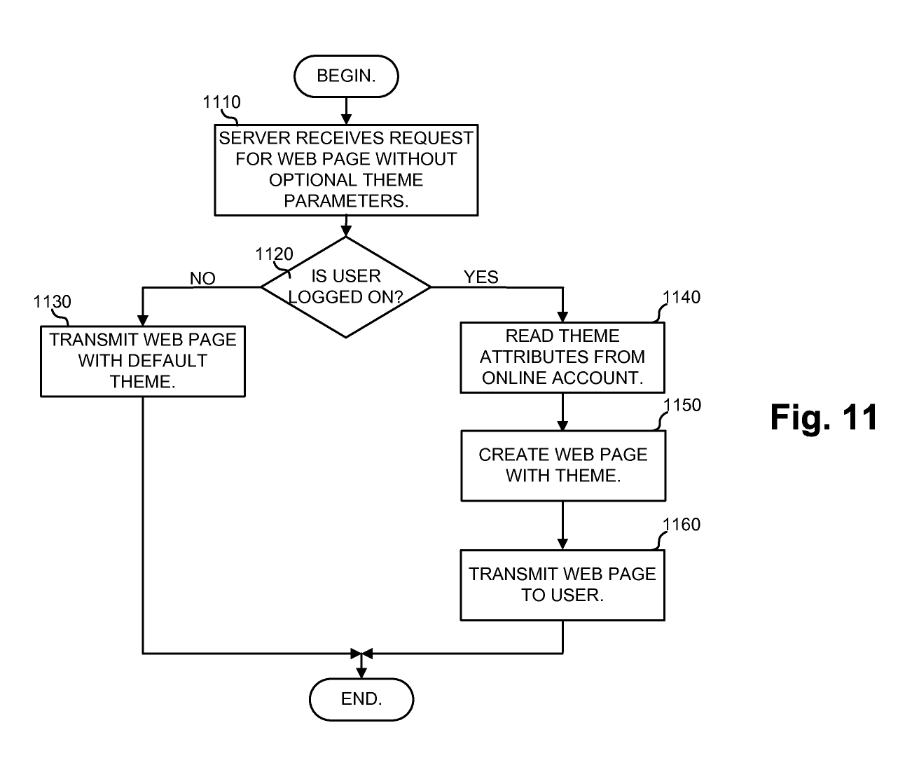

FIG. 11 is a flow chart illustrating exemplary operations relating to the theme of a graphical element presented in a browser. The operations shown in FIG. 11 may be performed by a server, such as server 210, in the process of receiving and responding to a user request for a web page.

Server 210 may receive a request for a web page that does not include a reference to a theme for graphical elements of the web page (block 1110). For example, instead of receiving a web page request with a query string, as discussed with respect to block 1010 (FIG. 10), the server may simply receive a request for a web page without additional theme related information. Server 210 may determine if the user is logged into an account known by server 210 (block 1120). If not, (block 1120—NO), server may transmit the web page with the default theme. If the user is logged in, however (block 1120—YES), server 210 may read the theme attributes associated with the user's account (block 1140), create a web page using the theme attributes (block 1150), and transmit the web page to the user (block 1160).

As described above in the discussion corresponding to FIGS. 8-12, a user or developer may create and easily distribute themes for user interface elements in a web page. Themes may be distributed as theme configuration files that include attributes corresponding to an API distributed by the entity controlling the web service. Themes, once applied, may be stored in an online account associated with the user.

### CONCLUSION

Implementations, described herein, may enable users to create and install custom themes for browser toolbars or for interface elements in web page. The themes may be themes that are distributed as configuration files, such as XML files. The configuration file may conform to an API describing the permissible form of the configuration file and a toolbar or web service may validate the configuration file before installing the toolbar theme.

Additionally, customizable visual themes were described as themes that may be applied to graphic user interface elements of web pages. These themes may be themes that are also distributed as configuration files, such as XML files, that may be installed from an option available through web page.

The foregoing description provides illustration and description, but is not intended to be exhaustive or to limit the invention to the precise form disclosed. Modifications and variations are possible in light of the above teachings or may be acquired from practice of the invention.

For example, while a series of blocks has been described with regard to FIGS. 4 and 10, the order of the blocks may be modified in other implementations. Further, non-dependent blocks may be performed in parallel.

Also, exemplary graphical user interfaces have been described with respect to FIGS. 1 and 7. In other implementations, the graphical user interfaces may include more, fewer, or different pieces of information.

Also, certain portions of the implementations have been described as “logic” or a “component” that performs one or more functions. The terms “logic” or “component” may include hardware, such as a processor, an ASIC, or a FPGA, or a combination of hardware and software (e.g., software running on a general purpose processor—creating a specific purpose processor).

It will be apparent that aspects described herein may be implemented in many different forms of software, firmware, and hardware in the implementations illustrated in the figures. The actual software code or specialized control hardware used to implement aspects does not limit the embodiments. Thus, the operation and behavior of the aspects were described without reference to the specific software code—it being understood that software and control hardware can be designed to implement the aspects based on the description herein.

Even though particular combinations of features are recited in the claims and/or disclosed in the specification, these combinations are not intended to limit the disclosure of the invention. In fact, many of these features may be combined in ways not specifically recited in the claims and/or disclosed in the specification. Although each dependent claim listed below may directly depend on only one other claim, the disclosure of the invention includes each dependent claim in combination with every other claim in the claim set.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

1. A method comprising:
providing, by a client device, an add-on toolbar that is installed separately from a browser executed by the client device,
the add-on toolbar implementing functions that extend functionality of the browser, and
the add-on toolbar including a selectable element that is used to indicate that a visual appearance of the add-on toolbar is to be changed;
receiving, by the client device, a first selection of the selectable element;
presenting, by the client device and based on the first selection, an interface for selecting a configuration file that describes a theme of the visual appearance of the add-on toolbar;
receiving, by the client device and via the interface, a second selection of the configuration file;
receiving, by the client device and based on the second selection, the configuration file;
validating, by the client device, the configuration file by verifying that the configuration file includes particular header information and conforms to an application program interface that specifies valid markup to determine that the configuration file is compatible with the add-on toolbar; and
updating, by the client device and after validating the configuration file, the theme of the visual appearance of the add-on toolbar to correspond to the theme described by the configuration file without affecting a visual appearance of the browser.

2. (canceled)

3. The method of claim 1, where the configuration file includes references to resources external to the configuration file.

4. The method of claim 3, where the references to resources external to the configuration file include links to images that are to be displayed as icons on the add-on toolbar.

5. The method of claim 1, where the add-on toolbar is not included as part of installation of the browser.

6. The method of claim 1, further comprising:
storing at the client device, based on the updating of the theme of the visual appearance of the add-on toolbar, the configuration file and resources required by the configuration file.

7. The method of claim 1, where the configuration file includes an extensible markup language (XML) file, a JavaScript Object Notation (JSON) file, or a Protocol Buffer file.

8. The method of claim 1, where the configuration file includes information regarding at least one of graphic icons shown on the add-on toolbar, a font used in the add-on toolbar, or a color scheme of the add-on toolbar.

9. A device comprising:
a memory; and
one or more processors to:
present a browser for display,
provide an add-on toolbar within the browser,
the add-on toolbar implementing functions that extend functionality of the browser, and
the add-on toolbar including a selectable element that is used to indicate that a visual appearance of the add-on toolbar is to be changed, detect a first selection of the selectable element of the add-on toolbar,
present, based on the first selection, an interface for selecting a configuration file that describes the visual appearance of the add-on toolbar,
receive, via the interface, a second selection of the configuration file,
validate, based on the second selection, the configuration file by verifying that the configuration file includes particular header information and conforms to an application program interface that specifies a valid markup attribute to determine that the configuration file is compatible with the add-on toolbar, and
update, after validating the configuration file, the visual appearance of the add-on toolbar to correspond to the visual appearance described by the configuration file without affecting a visual appearance of the browser.

10. The device of claim 9, where the configuration file is stored locally at the device.

11-12. (canceled)

13. The device of claim 9, where the configuration file includes references to resources external to the configuration file.

14. The device of claim 13, where the references to resources external to the configuration file include links to images that are to be displayed as part of the add-on toolbar.

15. The device of claim 9, where the add-on toolbar is not installed as part of installation of the browser.

16. The device of claim 9, where the configuration file includes an extensible markup language (XML) file, a JavaScript Object Notation (JSON) file, or a Protocol Buffer file.

17. The device of claim 9, where the visual appearance of the add-on toolbar defined by the configuration file includes at least one of graphic icons shown on the add-on toolbar, a font used in the add-on toolbar, or a color scheme of the add-on toolbar.

18. A non-transitory computer-readable medium containing instructions executable by at least one processor, the instructions comprising:
one or more instructions to provide an add-on toolbar that is installed separately from a browser,
the add-on toolbar implementing functions that extend functionality of the browser, and
the add-on toolbar including a selectable element that is used to indicate that a visual appearance of the add-on toolbar is to be changed;
one or more instructions to receive a first selection of the selectable element;
one or more instructions to present, based on the first selection, an interface for selecting a configuration file that describes a theme for the visual appearance of the add-on toolbar;
one or more instructions to receive, via the interface, a second selection of the configuration file;
one or more instructions to receive, based on the second selection, the configuration file;
one or more instructions to validate the configuration file by verifying that the configuration file includes particular header information and conforms to an application program interface that specifies valid markup; and
one or more instructions to change, after validating the configuration file, the visual appearance of the add-on toolbar to correspond to the theme described by the configuration file without affecting a visual appearance of the browser.

19. (canceled)

20. The non-transitory computer-readable medium of claim 18, where the configuration file includes references to resources external to the configuration file.

21. The non-transitory computer-readable medium of claim 18, further comprising:
one or more instructions to store, based on the changing of the visual appearance of the add-on toolbar, the configuration file and resources required by the configuration file.

22. The non-transitory computer-readable medium of claim 18, where the configuration file includes information regarding at least one of graphic icons shown on the add-on toolbar, a font used in the add-on toolbar, or a color scheme of the add-on toolbar.

23. (canceled)

24. A method comprising:
providing, by a device, an add-on toolbar,
the add-on toolbar including a selectable element that is used to indicate that a visual appearance of the add-on toolbar is to be changed;
receiving, by the device, a first selection of the selectable element;
providing, by the device and based on the first selection, an interface for selecting a configuration file that describes a theme for the visual appearance of the add-on toolbar;
receiving, by the device, a second selection of the configuration file;
validating, by the device, the configuration file by verifying that the configuration file includes particular header information and conforms to an application program interface that specifies a valid markup attribute;
extracting, by the device and after validating the configuration file, attributes from the configuration file; and
changing, by the device, the visual appearance of the add-on toolbar based on the attributes without affecting a visual appearance of the browser.

25-27. (canceled)

28. The method of claim 24, where the configuration file includes references to resources external to the configuration file.

29. A non-transitory computer-readable medium comprising:
one or more instructions that, when executed by at least one processor, cause the at least one processor to:
provide an add-on toolbar within a browser;
the add-on toolbar including a selectable element that is used to indicate that a visual appearance of the add-on toolbar is to be changed;
receive information indicating a first selection of the selectable element;
provide, based on the first selection, an interface for selecting a configuration file that describes a theme for the visual appearance of the add-on toolbar;
receive information indicating a second selection of the configuration file;
validate, after receiving the information indicating the second selection, the configuration file by verifying that the configuration file includes particular header information and conforms to an application program interface that specifies valid markup to determine that the configuration file is compatible with the add-on toolbar;
extract theme attributes from the configuration file after validating the configuration file; and
change the visual appearance of the add-on toolbar based on the theme attributes without affecting a visual appearance of the browser.

30. The non-transitory computer-readable medium of claim 29, further comprising:
one or more instructions that, when executed by the at least one processor, cause the at least one processor to:
receive the add-on toolbar from a first device associated with a first party; and
receive the configuration file from a second device associated with a second party,
the second party being different from the first party.

31. The non-transitory computer-readable medium of claim 30, where the first party and the second party are different from a third party that provides the browser.

32. The non-transitory computer-readable medium of claim 29,
where the add-on toolbar is different from another toolbar that is part of the browser.

33. The non-transitory computer-readable medium of claim 29,
where the visual appearance of the add-on toolbar defined by the configuration file includes information regarding a particular button, and
where the non-transitory computer-readable medium further comprises:
one or more instructions that, when executed by the at least one processor, cause the at least one processor to:
receive information indicating a third selection of the particular button, and
present, based on the third selection, a ranking of web pages.

34. (canceled)

35. The non-transitory computer-readable medium of claim 29, further comprising:
one or more instructions that, when executed by the at least one processor, cause the at least one processor to:
receive information indicating a third selection to customize a pop-up window associated with the browser, and
customize the pop-up window based on another theme described in another configuration file.

36. The non-transitory computer-readable medium of claim 29,
where the interface for selecting the configuration file includes:
a second selectable element to retrieve the configuration file from a local drive associated with the at least one processor, and
a third selectable element to retrieve the configuration file from a remote server, and
where the non-transitory computer-readable medium further comprises:
one or more instructions that, when executed by the at least one processor, cause the at least one processor to:
receive information indicating a third selection of the second selectable element or the third selectable element, and
retrieve the configuration file based on the third selection.
